(19) United States
(12) Patent Application Publication
(10) Pub. No.: US 2021/0139686 A1
(43) Pub. Date: May 13, 2021

(54) RESINS HAVING A HIGH METHYLOL TO DIBENZYL ETHER RATIO AND METHODS OF MAKING THE SAME

(71) Applicant: SI GROUP, INC., Schenectady, NY (US)

(72) Inventors: Alexandra KRAWICZ, Schenectady, NY (US); John Morgan WHITNEY, Schenectady, NY (US); Timothy E. BANACH, Glenville, NY (US)

(21) Appl. No.: 16/487,704

(22) PCT Filed: Feb. 15, 2018
(86) PCT No.: PCT/US2018/018348

§ 371 Date: Aug. 21, 2019

Related U.S. Application Data
(60) Provisional application No. 62/463,410, filed on Feb. 24, 2017.

(51) Int. Cl. C08L 23/22; C08G 8/12

(52) U.S. Cl. CPC C08L 23/22; C08G 8/12

(57) ABSTRACT

This invention relates to resins having a molar ratio of methylol groups to ether groups in the resin is from 0.5:1 to about 2:1. Methods for making the composition are also provided. A bladder formulation comprising resins of the invention is also provided. A vulcanized elastomer composition prepared by vulcanizing the bladder formulation of the invention is also provided. A method of increasing thermal stability in a rubber by curing said rubber with a resin of the invention is also provided.

This application claims priority to U.S. Provisional Application No. 62/463,410, filed Feb. 24, 2017, which is herein incorporated by reference in its entirety.

### FIELD OF THE INVENTION

This invention generally relates to a resin comprising a high methylol to dibenzyl ether ratio and a process for making the resin. This invention also generally relates to a method for increasing the thermal stability in a rubber by modifying said rubber with a resin comprising a high methylol to dibenzyl ether ratio.

### BACKGROUND

Butyl rubber, a widely used industrial rubber, is typically cross-linked or vulcanized by one of three basic methods. These are (1) accelerated sulfur vulcanization, (2) cross-linking with dioxime and related dinitroso compounds, and (3) a phenol-formaldehyde (resol) resin cure. Curing with phenol-formaldehyde resins occurs through the reaction of the methylol groups of the phenols or resin with the uncured rubber to form cross-linked structures. Mechanisms of such curing of butyl rubber have been proposed (see for example R.P. Lattimer et al, Rubber Chemistry 7 Technology, volume 62, pages 107-123, 1988 which is hereby incorporated by reference).

European Patent No. 1,016,691 to Bayer Inc., which is hereby incorporated by reference, found that the more methylene bridges in relation to the dibenzyl ether bridges correlated to an improvement in the heat stability of the rubber compounds. This is likely due to less residual reactive moieties from the resin, after the rubber is cured. Dibenzyl ether bridges form upon condensation with terminal methylol groups. This problem is often exacerbated during traditional isolation techniques.

Resins with high methylol content, however, are difficult to synthesize. Conventional reaction procedures and reaction conditions in the resin-forming processes produce methylols, but these are susceptible to additional condensation reactions, forming dibenzyl ethers during the isolation steps.

Therefore, there is a need in the art to develop synthetic procedures that are capable of producing resins having a high methylol content and low dibenzyl ether content. This invention satisfies that need.

### SUMMARY OF THE INVENTION

One aspect of the invention relates to a resin having one or more compounds of formula (I):

[chemical structure]

wherein: each R is independently a H, C₁ to C₃₀ alkyl, phenyl, or arylalkyl; each X is independently selected from the group consisting of —CH₂—, —CH(R₁)—, —(CH₂—O—CH₂)ₙ—, and —C(R₁)₂—; each Y is independently selected from —OH, —Br, and —Cl; Z is either

[chemical structure]

or R; each R₁ is independently a C₁ to C₆ alkyl; m is an integer from 1 to 10; each n is independently an integer from 1-3; s and p are each independently 0 or 1, provided that at least one of s or p is 1; and wherein one or more X units are ether groups (—CH₂—O—CH₂—) such that the molar ratio of methylol groups to ether groups in the resin is from 0.5:1 to about 2:1.

Another aspect of the invention relates to a process for preparing a resin composition with a high methylol content, comprising the steps of: a) reacting an alkylphenol with aldehyde in an aprotic solvent in the presence of a base catalyst at a temperature ranging from about 80 to about 160° C. to form a first resin, wherein the aldehyde:phenol molar ratio is from about 0.3:1 to about 0.9:1; b) reacting the first resin with additional aldehyde at a temperature ranging from about 40 to about 75° C., wherein the aldehyde:phenol molar ratio is from about 0.4:1 to about 2.0:1; c) neutralizing the resin with an acid to a pH of less than 7 to form a modified resin with methylols; and d) subjecting the modified resin to a rapid devolatilization technique to remove the solvent while preserving methylol groups on the modified resin.

Another aspect of the invention relates to a process for preparing a resin composition with a high methylol content, comprising the steps of: a) reacting an alkylphenol with aldehyde in an aprotic solvent in the presence of an acid catalyst at a temperature ranging from about 80 to about 160° C. to form a first resin, wherein the aldehyde:phenol molar ratio is from about 0.3:1 to about 0.9:1; b) adding excess base catalyst to neutralize the acid catalyst, for instance by raising the pH above 7; c) reacting the first resin with additional aldehyde at a temperature ranging from about 40 to about 75° C., wherein the aldehyde:phenol molar ratio is from about 0.4:1 to about 2.0:1; d) neutralizing the resin with an acid to a pH of less than 7 to form a modified resin with methylols; and e) subjecting the modified resin to a rapid devolatilization technique to remove the solvent while preserving methylol groups on the modified resin.

The resulting resin composition demonstrates a surprisingly positive impact on the thermal stability of the rubber compound. Accordingly, another aspect of the invention relates to a method of increasing thermal stability in a rubber by modifying said rubber with a resin of the invention, wherein the modified rubber, when subjected to a heat treatment carried out at a temperature of about 140-180° C., such as 150-170° C., or about 160° C., for at least 72 hours, undergoes a change in modulus at 100% elongation, between 24 hours and 72 hours of the heat treatment, of less than 25%.

An aspect of the invention also relates to a heat stable vulcanized elastomer composition resulting from usage of the above mentioned resin with an elastomer, a halogen-containing compound, and other components known to those skilled in the art.

### BRIEF DESCRIPTION OF THE DRAWINGS

FIG. 1 shows cure curves of five resins obtained using an RPA (Rubber Process Analyzer.) Two commercially available resins used to cure butyl rubber are used as standards in this study. Standard A is a commercially available curing resin with a total methylol content ranging from 8 to 11%, as measured via the dehydration method based on a dehydration test. Standard B is a commercially available curing resin with a total methylol content ranging from 6 to 9%, as measured via the dehydration method. Based on the percent methylol content, Standard B was compounded and tested for material properties at two loadings: 10 phr, a typical resin load used for this type of rubber compound and 13.3 phr an amount adjusted to contain the same amount of reactive methylols, and ether groups as 10 phr of Standard A. Two resin batches according to the invention were synthesized and based on the percent methylol content, the resins were compounded and tested for material properties at two loadings: 10 phr, a typical resin load used for this type of rubber compound and 11.8 phr an amount adjusted to contain the same amount of reactive methylols, and ether groups as 10 phr of Standard A. Resin 1 has a melting point of 110° C. and Resin 2 has a melting point of 100° C.

FIG. 2 is a chart showing the extent of cure of the five resins by RPA.

FIG. 3 is a chart showing heat ageing results of the five resins. Each point is an average of 3 samples measured at different time intervals.

FIG. 4 is a chart showing percent change in modulus of the five resins between 0 and 12 h of the heat ageing test.

FIG. 5 is a chart showing percent change in modulus of the five resins between 12 and 72 h of the heat ageing test.

FIG. 6 is a chart showing percent change in modulus between 24 and 72 h of the heat ageing test.

### DETAILED DESCRIPTION OF THE INVENTION

This invention relates to the surprising discovery that resins with a high ratio of methylol groups to ether groups were able to be prepared and isolated, using a new method, reaction conditions, and the use of a rapid devolatilization isolation technique (e.g., thin film evaporation). By using this process the resin structure is largely conserved and ether formation is inhibited to a large extent. In processes using traditional kettle distillations, the resins tend to undergo ether-forming condensation reactions via the methylol groups, and thus tend to have a low ratio of methylol groups to ether groups. Conserving a high ratio of methylol groups to ether groups in a resin is desirable because beneficial thermal stability properties are associated therewith.

One aspect of the invention relates to a resin having one or more compounds of formula (I):

[chemical structure]

wherein: each R is independently a H, C₁ to C₃₀ alkyl, phenyl, or arylalkyl; each X is independently selected from the group consisting of —CH₂—, —CH(R₁)—, —(CH₂—O—CH₂)ₙ—, and —C(R₁)₂—; each Y is independently selected from —OH, —Br, and —Cl; Z is either

[chemical structure]

or R; each R₁ is independently a C₁ to C₆ alkyl; m is an integer from 1 to 10; each n is independently an integer from 1-3; s and p are each independently 0 or 1, provided that at least one of s or p is 1; and wherein one or more X units are ether groups (—CH₂—O—CH₂—) such that the molar ratio of methylol groups to ether groups in the resin is from 0.5:1 to about 2:1. Alternatively, no ether groups are present in the resin.

The resins have a high ratio of methylol groups to ether groups. The ratio of methylol groups to ether groups in the resin is from 0.5:1 to about 2:1, and all ranges there between. For instance, the ratio of methylol groups to ether groups in the resin is from about 0.5:1 to about 1.8:1, or from 0.6:1 to about 1.5:1, or from about 0.8:1 to about 1.1:1, or from about 0.9:1 to about 1:1. The ratio of methylol groups to ether groups in the resin of the invention is higher than commercially available resins, which typically do not exceed a ratio of methylol groups to ether groups of around 0.3:1. Without being bound by any theory, it is believed that employing a resin having a high ratio of methylol groups to ether groups as a curing agent in rubber compounds (e.g., butyl rubbers) imparts beneficial properties to the product rubber, such as increased thermal stability.

The methylol content is determined by an acid dehydration procedure, although other procedures known to one skilled in the art may be used. In a typical acid dehydration procedure, the resin is dissolved in a suitable solvent solution (e.g., phenol/toluene) and a strong acid (e.g., sulfuric acid) is added to catalyze the reaction of methylols and dibenzyl ethers with the phenol. One mole of water is generated via condensation per mole of methylol or dibenzyl ether. The generated water is collected in a Dean Stark apparatus and the quantity of water collected is used to determine the percent methylol content of the resin. The methylol content measured by this method includes both methylols and dibenzyl ethers.

The compounds of formula (I) comprise phenolic moieties linked together by X units, wherein the terminal phenolic moieties of the polymer contain methylol groups. Each X is independently selected from the group consisting of —CH₂—, —CH(R₁)—, —(CH₂—O—CH₂)ₙ—, and —C(R₁)₂—, where n is an integer from 1-3. At least one X in the resin is an ether group (—(CH₂—O—CH₂)ₙ—). In typical examples, each X is either —CH₂— or —(CH₂—O—CH₂)ₙ—, where n is an integer from 1-3. For instance, each X may be either —CH₂— or —CH₂—O—CH₂—.

Each phenolic moiety in the compounds of formula (I) may be substituted or unsubstituted at the para position. For instance, all of the phenolic moieties may be substituted at the para position. In another example, some of the phenolic moieties may be substituted at the para position, while other phenolic moieties may be unsubstituted at the para position. An R group is present at the para position on the phenolic moieties. Each R is independently H, C₁ to C₃₀ alkyl, phenyl, or arylalkyl. For instance, each R may be a C₄-C₁₂ alkyl moiety, or a C₄-C₈ alkyl, such as butyl, octyl, tert-butyl, or tert-octyl.

The Z groups of the resin are either

[chemical structure]

or R. In a preferred embodiment, Z is

[chemical structure]

Another aspect of the invention relates to a process for preparing a resin composition with a high methylol content, comprising the steps of: a) reacting an alkylphenol with aldehyde in an aprotic solvent in the presence of a base catalyst at a temperature ranging from about 80 to about 160° C. to form a first resin, wherein the aldehyde:phenol molar ratio is from about 0.3:1 to about 0.9:1; b) reacting the first resin with additional aldehyde at a temperature ranging from about 40 to about 75° C., wherein the aldehyde:phenol molar ratio is from about 0.4:1 to about 2.0:1; c) neutralizing the resin with an acid to a pH of less than 7 to form a modified resin with methylols; and d) subjecting the modified resin to a rapid devolatilization technique to remove the solvent while preserving the methylol groups—or limiting the condensation of methylol groups that form dibenzyl ethers or methylene links or both—on the modified resin.

After the first stage of this reaction, and before the second aldehyde addition step, there is typically between about 0% to about 40% unreacted alkylphenol. For instance, the amount of unreacted alkylphenol may be between about 5% to about 35%, about 10% to about 35%, about 15% to about 30%, about 19% to about 29%, about 21% to about 28%, about 23% to about 26%, or about 24% to about 25%. When PTOP, for example, is used as the alkylphenol, there is typically between about 19% to about 29% unreacted PTOP after the first stage of the reaction. The unreacted alkylphenol may become methylolated after the second aldehyde addition step. Accordingly, bis-methylolated alkylphenol (e.g., PTOP) may be present in the final product which allows for a wider range of resole chain lengths available to cross-link butyl rubber.

The process for preparing a resin composition with a high methylol content produces a resin having a ratio of methylol groups to ether groups in the resin composition of from 0.5:1 to about 2:1, and all ranges there between. For instance, the ratio of methylol groups to ether groups in the resin is from about 0.5:1 to about 1.8:1, or from 0.5:1 to about 1.5:1, or from about 0.5:1 to about 1:1, or from about 0.5:1 to about 0.7:1, or from about 0.5:1 to about 0.6:1, or from about 0.8:1 to about 1.1:1, or from about 0.9:1 to about 1:1. Alternatively, the process may also produce a resin having no ethers present in the resin composition.

Additionally, the resin composition produced by this process has a low amount of unreacted monomers. For instance, the unreacted alkylphenol monomer content is typically less than 1%, less than 0.5%, or less than 0.2%.

The process has two main phases: a base-catalyzed formation of alkylphenols with methylol groups, and their subsequent condensation and azeotropic distillation. The aldehyde:phenol molar ratio in step (a) may be from about 0.3:1 to about 0.9:1, for instance, from about 0.3:1 to about 0.7:1, from about 0.4:1 to about 0.7:1, or from about 0.5:1 to about 0.6:1. After cooldown to a temperature in the range of 40 to about 75° C., for instance around 60° C. followed by a second formaldehyde addition and quenching of the base catalyst with an acid, such as sulfuric acid. The resin is changed to a resole with an aldehyde:phenol molar ratio, in step (b), from about 0.4:1 to about 2.0:1, for instance, from about 0.4:1 to about 1.8:1, from about 0.8:1 to about 1.8:1, or from about 1.2:1 to about 1.8:1. Reaction step (a) and/or reaction step (c) may be further subjected to vacuum-mediated azeotropic distillation to remove water.

The step of subjecting the modified resin to a rapid devolatilization technique removes the solvent while preserving the methylol groups on the modified resin. The rapid devolatilization technique can be performed using a thin film evaporator (TFE). TFE is a technique for processing difficult-to-handle products, such as viscous or heat-sensitive materials. The basic principle of operation is to pass the resin solution through a heated body of the evaporator, which may be cylindrical or conical depending on the design, and agitate the resin solution using blades powered by a motor (or, optionally, no blades and operated by gravity, pulling the resin down while the solvent boils out the top). The agitation creates a turbulent flow and distributes the resin solution in a thin film onto the inner circumference of the body.

In one example, the resin solution (condensate) is held at 49-66° C. and fed into the TFE, for instance a Filmtruder, manufactured by Buss-SMS-Canzler GmbH. The body of the TFE is heated in an oil bath, where the oil temperature ranges between 150-200° C., for example between 163-192° C. There are several types of thin-film evaporators, for example wiped-film evaporators and agitated-film evaporators may be used. The instruments may be horizontal or vertical with a range of different rotor types, which all can be used to process the resin. They are manufactured by several different companies. In addition, a short path or molecular distillation, falling film evaporator may be used.

Prior to the rapid devolatilization step, the water may be azeotropically distilled off under vacuum. Depending on the devolatilization technique used, the percent solids can be adjusted to about 58-60%. This can be done by vacuum distillation, for instance vacuum distillation at 60° C., or adding xylene. As one skilled in the art will appreciate, the azeotropic distillation and percent solid adjustment is often used to achieve the desired viscosity and percentage solids content for processing. This step is common when using certain TFE techniques.

By isolating the resins using rapid devolatilization techniques, as opposed to more traditional methods such as batch distillation, the methylols of the resins remain largely unreacted, thus providing for a higher ratio of methylol:ether than conventional isolation steps allow for. When TFE is used, the thin film evaporation may be performed with or without a vacuum, and performed in a continuous or semi-continuous manner.

The rapid devolatilization technique removes greater than 99% of the solvent at temperatures in the range of 145-175° C. Typically, this can occur in less than 5 minutes, for instance, in less than 4 minutes, less than 3 minutes, less than 2 minutes, or less than 1 minute.

By using a rapid devolatilization technique, the process for preparing a resin composition with a high methylol content does not include a batch distillation step, such as a vacuum-mediated batch distillation step.

A variety of alkylphenols, including C₁-C₃₀ alkylphenols, may be used in the process for preparing a resin composition with a high methylol content. For instance, short chain alkylphenols (i.e., C₁-C₁₂ substituents), such as para-tert-butylphenol or para-tert-octylphenol, or a combination thereof may be used. Alternatively, long chain alkylphenols (i.e., C₁₂-C₃₀ substituents) may be used. In one embodiment, the alkylphenol used in the process for preparing a resin composition with a high methylol content contains C₄-C₁₂ alkyl groups. The alkylphenol may be para-substituted or it may be ortho-substituted.

The alkylphenol may be a mixture comprising more than one alkylphenols containing C₁-C₃₀ alkyl groups. For instance, the alkylphenol may be a mixture comprising more than one alkylphenols containing C₄-C₁₂ alkyl groups, a mixture containing any of para-tert-butylphenol, para-tert-octylphenol, and/or para-nonylphenol, or combinations thereof.

The alkylphenol may be purified or unpurified (i.e., formed in-situ and used without pre-purification). Suitable means of preparing in-situ alkylphenols is described in U.S. patent application Ser. No. 14/514,636, filed Oct. 15, 2014, which is hereby incorporated by reference. One skilled in the art will appreciate that when synthesizing an alkylphenol in-situ, in addition to monoalkylated phenols, byproducts such as dialkylated phenols may form. Thus, in some embodiments, a dialkylated phenol (e.g., di-tert-octyl phenol) may be incorporated into the resin of formula (I) (i.e., when Z═R). For example when using PTOP formed through an in-situ process, a resin of formula (I) may include the following structure:

[chemical structure]

Aldehydes suitable for use in the process for preparing a resin composition with a high methylol content include those known to one skilled in the art, such as formaldehyde, acetaldehyde, propionaldehyde, butyraldehyde, pentanal, hexanal, and heptanal. The typical aldehyde used in the process is formaldehyde. When using formaldehyde, a good reflux should be obtained once part of the formaldehyde is added; the particular temperature may vary depending on starting material loads.

Base catalysts suitable for use in the process for preparing a resin composition with a high methylol content include ammonium hydroxide; tertiary amines such as triethylamine, triethanolamine, diethyl cyclohexyl amine, triisobutyl amine; alkali and alkaline earth metal oxides and hydroxides such as potassium hydroxide and others known by one skilled in the art.

Any aprotic solvent known by one skilled in the art may be in the process for preparing a resin composition with a high methylol content. For instance, the solvent may be toluene or xylene.

The processes described herein results in a heat reactive resin with a methylol to dibenzyl ether group ratio of at least 0.5:1, or at least 0.9:1. This is a substantial increase over commercially available resins which typically results in a methylol to ether ratio of about 0.3:1 to about 0.5:1. The process described herein minimizes the time and heat during the isolation step therefore preserving more methylols. Moreover, this process results in a composition where there are more methylene linkages than dibenzyl ether linkages.

Without being bound by any theory, it is believed that the high methylol content may improve the curing properties of the product and its consistency in performance. The process allows for control over the methylol and ether content producing a resin with a consistent composition and thus consistent reactivity. Also, a high methylol content will require less resin for reacting/curing all of the unsaturated groups in the butyl rubber (IIR) elastomer. Furthermore, the high methylol content may result in faster cure rates, and better tensile properties, improved high temperature ageing.

Another aspect of the invention relates to a process for preparing a resin composition with a high methylol content, comprising the steps of: a) reacting an alkylphenol with aldehyde in an aprotic solvent in the presence of an acid catalyst at a temperature ranging from about 80 to about 160° C. to form a first resin, wherein the aldehyde:phenol molar ratio is from about 0.3:1 to about 0.9:1; b) adding excess base catalyst to neutralize the acid catalyst, for instance by raising the pH above 7; c) reacting the first resin with additional aldehyde at a temperature ranging from about 40 to about 75° C., wherein the aldehyde:phenol molar ratio is from about 0.4:1 to about 2.0:1; d) neutralizing the resin with an acid to a pH of less than 7 to form a modified resin with methylols; and e) subjecting the modified resin to a rapid devolatilization technique to remove the solvent while preserving methylol groups on the modified resin.

One skilled in the art will appreciate that the resin composition with a high methylol content prepared by the acid-catalyzed process of this aspect is structurally the same, or substantially the same, as that produced in the base-catalyzed aspect. Accordingly, the embodiments and characteristics as described above for the base-catalyzed aspect all hold true for the acid-catalyzed aspect.

Acid catalysts suitable for use in the process for preparing a resin composition with a high methylol content include p-toluene sulfonic acid, dodecylbenzene sulfonic acid, xylene sulfonic acid, or combinations thereof. Others acid catalysts known by one skilled in the art may also be used.

Another aspect of the invention relates to a bladder formulation comprising an uncured elastomer, a halogen-containing compound, and the resin of the invention. The bladder formulation may further comprise an activator, process oil, stearic acid, filler, lubricant, plasticizer, dispersant and/or extender, and other components known in the art.

Bladder formulation processes are known to those of skill in the art. For instance, the rubber and other components of the formulation may be compounded in a mixer, passed through a two-roll mill to produce rubber sheets. Then the rubber sheet compound is then cured at 190-200° C., for instance 193° C., in a press. The cure time may be determined by examining the rubber compound with a RPA in the Moving Die Rheometer (MDR) mode and adding 4 minutes to the total cure time to ensure complete curing. An example of the process may be found in the reference book by Brendan Rodgers, “Rubber Compounding: Chemistry and Applications,” at 128-129, (2nd ed. 2015), which is hereby incorporated by reference.

The elastomer is typically a butyl rubber, although other elastomers such as halogenated butyl rubbers or other non-butyl rubber elastomers may also be used. Butyl rubber is produced commercially by copolymerizing isobutylene with small amounts of isoprene. Butyl rubber in the uncured state is a weak material having the typical properties of a plastic gum; it has no definite elastic limit, that is, upon slow application of tensile stress, it elongates almost indefinitely without breaking, and exhibits virtually no elastic recovery after the stress is removed. On the other hand, vulcanized or cured butyl rubber is a strong, non-plastic material; it has an elastic limit, as well as the ability to return substantially to its original length after being stretched as much as several hundred percent.

The curing agents generally used include phenols and phenol-formaldehyde resins produced by condensation of a phenol with formaldehyde in the presence of base. Typical agents include 2,6-dihydroxymethyl-4-alkyl phenols and their polycyclic condensation polymers. Examples are given in U.S. Pat. No. 2,701,895 (Feb. 15, 1955, which is hereby incorporated by reference).

Cured butyl rubber has a number of uses, one of which is in tire-curing bladders. Tire-curing bladders are inflatable and have an annular toroidal form. The curing bladder is disposed within a raw tire casing as an aid in shaping a tire by applying internal heat and pressure to the tire casing in a moulding press in which the tire is vulcanized. For this purpose, the bladder is inflated with a fluid heating medium, usually steam, under pressure, which causes the bladder to expand and thereby forces the tire casing into close conformity with the vulcanizing mould. Upon completion of the vulcanization, the curing bladder is removed from the tire, and inserted in another raw tire for a repetition of the curing operation. The bladder is thus repeatedly used for a number of cycles.

Curing butyl rubber with phenol-formaldehyde resins having low methylol to ether ratios (e.g., less that 0.3:1) results in hardening or ageing of the butyl rubber at elevated temperatures, such as those reached during the process of curing tires, e.g., above 160° C. As a result, butyl rubbers cured with phenol-formaldehyde resins having low methylol to ether ratios have a limited life in traditional applications.

A halogen-containing compound may be present in the formulation. Examples of halogen-containing compounds include organic compounds such as olefin-containing polymers having pendant chlorine atoms, such as polychloroprene, available under such trade-marks as Baypren (Bayer), Butachlor (Distagul) and Neoprene (Du Pont). The amount present in the formulation is typically within the range of about 1 to about 10 parts, for instance, about 4 to about 6 parts, or about 5 parts per 100 parts of rubber. Alternatively, chlorine-containing salts, for example stannous chloride, can be used as the halogen-containing compound. It is possible that the halogen, e.g., chlorine or bromine, atom is provided as a component of one of the other ingredients of the formulation, rather than being provided by a separately added compound. For instance, it is possible to use a chlorinated or brominated butyl rubber, or a chlorinated or brominated polycyclic phenol-formaldehyde resin, rather than a separately added compound such as polychloroprene or stannous chloride.

Many suitable process oils known to those skilled in the art may be used in the formulation. Examples of suitable process oils include castor oil and paraffinic oils.

The formulation can contain an activator. For instance, zinc oxide may be added as an activator, suitably in an amount of up to about 8 parts, such as about 5 parts, per 100 parts of rubber. Stearic acid can also be added, to assist in solubilizing the zinc oxide in the formulation.

The amount of resin present in the formulation is typically within the range of about 6 to about 12 phr. For instance, the amount of resin in the formulation is from about 7 to about 12 phr, or from about 8 to about 11 phr, or about 10 phr.

Fillers may be added to the formulation. Examples of fillers include talc, calcium carbonate, clay, silica, titanium dioxide, and carbon black. The amount of filler present in the formulation is typically within the range of about 40-80 parts, such as about 45-60 parts, or about 50 parts, per 100 parts of rubber.

The formulation described may be made by mixing the components of the formulation described above, and additionally any other desired optional ingredients such as accelerator, extender, lubricant, plasticizer, and the like, in any typical manner used in the rubber industry, e.g. on a mill or in an internal mixer.

The bladder formulation may be vulcanized through vulcanization techniques known in the art. Using the resins of the invention in the vulcanized elastomer provides the formulation with low amount of unreacted monomers. For instance, the unreacted monomer content is typically less than 1%, less than 0.5%, or less than 0.2%.

### EXAMPLES

The following examples are given as particular embodiments of the invention and to demonstrate the practice and advantages thereof. It is to be understood that the examples are given by way of illustration and are not intended to limit the specification or the claims that follow in any manner.

### Example 1A: General Base-Catalyzed Resin Synthesis Process

Resins were synthesized via a base catalyzed process. In the first stage, the alkylphenol, such as para-tert-octylphenol (PTOP), was reacted with formaldehyde in a presence of a basic catalyst, such as sodium hydroxide. The reaction was carried out under reflux conditions. Upon consumption of the formaldehyde the water generated in the reaction was azeotropically distilled and after that the reaction was cooled to 60° C. More formaldehyde was added and the reaction was continued until most of the formaldehyde was consumed. The catalyst was quenched with an acid, such as sulfuric acid. This was followed by an extraction after which the aqueous phase was removed. The organic phase was washed with water and aqueous phase was removed once again. This was followed by a second azeotropic distillation at 60° C. and vacuum to remove any remaining water, followed by a vacuum distillation to adjust the percent solids of the condensate solution to 60%. The resin was isolated using a Filmtruder thin film evaporator to remove xylene below 0.4% and PTOP to below 0.2%. The ball and ring melt point was adjusted to 95-110° C.

### Example 1B: Exemplified Base-Catalyzed Resin Synthesis Process

PTOP (330.0 g; 1.60 mol) and xylene (212.0 g; 2.00 mol) were loaded into a reaction kettle and heated to 98-103° C. The reaction was stirred until PTOP was fully dissolved, whereupon 50% caustic soda (32.0 g; 0.40 mol) was added and the temperature was observed to increase by ˜20° C. The reaction was stirred until the caustic soda dissolved, at which point 50% formaldehyde (52.80 g; 0.88 mol) was added at a temperature of 98-103° C. over approximately one hour. The batch was observed to start refluxing upon addition of formaldehyde. The temperature was held for one hour and monitored for free formaldehyde. If needed, the reaction was allowed to continue until the formaldehyde was consumed.

The water was azeotropically distilled off at a typical temperature of 145° C. The batch was cooled to 50-60° C. and additional formaldehyde was added over about 1.5-2 hours. The reaction was held at 60° C. until the free formaldehyde content was from 1-3.5%. Once the formaldehyde is in this range, 68% sulfuric acid (28.4 g; 0.20 mol) was added to quench the reaction. The reaction as allowed to continue stirring at 60° C. for 30-60 minutes until the mixture became homogeneous and the color was not opaque. The agitation was stopped and the reaction phases were allowed to separate for 30-60 minutes. The aqueous layer was removed. A pH of 2-4.5 is typically expected for the aqueous layer.

Water (66.0 g; 3.66 mol) was added to the organic layer and the mixture was stirred for 30-60 minutes, at which point stirring was stopped and the phases were allowed to separate for 30-60 minutes. The aqueous phase was then removed.

The water was azeotropically distilled off under vacuum at a temperature not exceeding 60° C. The percent solids were measured and adjusted to 58-60%, if necessary, either by vacuum distillation at 60° C. or adding xylene. The condensate was fed through the rapid devolatilization system and the temperature, vacuum, and feed rate were adjusted to achieve desired specifications.

The exemplified base-catalyzed process is shown in the following scheme:

[chemical structure]

The resin prepared in this Example was calculated to have the following distribution, as analyzed by ¹H NMR:

| | dibenzyl | |
|---|---|---|
| methylol | ether | methylene |
| groups | groups | groups |
| 23.4% | 27.0% | 49.3% |

### Example 1C: General Acid Catalyzed Resin Synthesis Process (Prophetic)

Resins are synthesized via an acid-catalyzed process. In the first stage, the alkylphenol, such as para-tert-octylphenol (PTOP), is reacted with formaldehyde in a presence of an acid-catalyst, such as dodecylbenzene sulfonic acid. The reaction is carried out under reflux conditions. Upon consumption of the formaldehyde, the water generated in the reaction is azeotropically distilled and after that the reaction is cooled to 60° C. The acid-catalyst is neutralized with a suitable base such as NaOH, and more formaldehyde is added and the reaction is continued until most of the formaldehyde is consumed. The reaction is quenched with an acid, such as sulfuric acid. This is followed by an extraction after which the aqueous phase is removed. The organic phase is washed with water and aqueous phase is removed once again. This is followed by a second azeotropic distillation at 60° C. and vacuum to remove any remaining water, followed by a vacuum distillation to adjust the percent solids of the condensate solution to 60%. The resin is isolated using a Filmtruder thin film evaporator to remove xylene.

The acid-catalyzed process is shown in the following scheme, using PTOP as the alkylphenol:

[chemical structure]

### Example 2: Rubber Compounding

The resin was compounded with a masterbatch composed of: 100 phr isobutylene-isoprene 268 rubber (butyl rubber), 50 phr carbon black 330, 5 phr castor oil, 5 phr zinc oxide, and 10 phr Neoprene “W”. Stearic acid may also be present, for instance at 1 phr. The rubber was cured in the RPA at 193° C. in the MDR setting to find the time to cure to 90% (t90). The specimens for tensile testing were prepared by pressing the rubber compound with a heated press for t90+4 min. The specimens were cut out and part of them were tested using an Instron for tensile properties, while the rest was placed in an oven at 160° C. for heat aging. The aged specimens were tested for tensile properties after different aging times.

### Example 3: Rubber Application Testing

Two resins of the invention, Resin 1 and Resin 2, were evaluated with an mp of 110° C. for Resin 1 and 100° C. for Resin 2, both of which had a high methylol to ether ratio of 0.9, which was determined using ¹H NMR. The cure properties of the resins were compared with Standard A and Standard B resins. Upon heating the resins at 193° C., Resins 1 and 2 were observed to have a comparable rate of cure as Standards A and B, as shown if FIG. 1, and a comparable extent of cure, as shown in FIG. 2.

Rubber compounds prepared according to Example 2 with the different resins were heat aged in an oven at 160° C. and their tensile properties were examined at different time intervals in accordance with the ASTM D638 Standard Test Method for Tensile Properties of Plastics. After compounding the rubber and all other formulation components, the rubber was formed into sheets using a two-roll mill. The rubber sheets were cured using a press and the time found using the RPA (T90+4 min) from Example 2. Afterwards the sheets were cut into dog-bone-shaped specimens and used for the tensile testing. Some specimens were tested right away, and others were heat aged in an oven at 160° C. and tested after different amounts of time. The tensile properties were tested using an Instron and applying strain (elongation) to the specimens and recording the stress. The stress at 100% elongation was measured in accordance with the ASTM D638 Standard Test Method for Tensile Properties of Plastics, at different time intervals for Resin 1 and Resin 2, and compared to Standard A and B, the results of which can be seen in FIG. 3. Under heat treatment at 160° C., Standards A and B broke after 24 hours.

The percent change in modulus at 100% elongation for Resin 1 and Resin 2 was compared to Standard A and B at different time intervals. Between 0-12 hours, the percent change in modulus at 100% elongation was smaller for Resin 1, and slightly larger for Resin 2, compared to Standards A and B, as can be seen in FIG. 4. The percent change in modulus at 100% elongation between 12-72 hours and 24-72 hours was significantly less for Resins A and B, compared to Standards A and B, as can be seen in FIGS. 5 and 6.

Accordingly, another aspect of the invention is a method of increasing thermal stability in a rubber composition by curing said rubber composition with a resin of the invention, wherein the cured rubber composition, when subjected to a heat treatment carried out at a temperature of 160° C. for at least 72 hours, undergoes a change in modulus at 100% elongation, between 24 hours and 72 hours of the heat treatment, of less than 25%, less than 15%, less than 10%, or less than 5%.

We claim:

1. A resin having one or more compounds of formula (I): [chemical structure]
wherein:
each R is independently a H, C₁ to C₃₀ alkyl, phenyl, or arylalkyl;
each X is independently selected from the group consisting of —CH₂—, of —CH₂—, —(CH₂—O—CH₂)ₙ—, and —C(R₁)₂—;
each Y is independently selected from —OH, —Br, and —Cl;
Z is either [chemical structure]
or R;
each R₁ is independently a C₁ to C₆ alkyl;
m is an integer from 1 to 10;
s and p are each independently 0 or 1, provided that at least one of s or p is 1;
each n is independently an integer from 1-3; and
wherein one or more X units are ether groups (—CH₂—O—CH₂—) such that the molar ratio of methylol groups to ether groups in the resin is from 0.5:1 to about 2:1.

2. The resin of claim 1, wherein each X is independently selected from the group consisting of —CH₂— or —(CH₂—O—CH₂)ₙ—, and n is an integer from 1-2.

3. The resin of claim 1, wherein the ratio of methylol groups to ether groups is from 0.6:1 to about 1.5:1.

4. The resin of claim 3, wherein the ratio of methylol to groups to ether groups is from about 0.8:1 to about 1.1:1.

5. The resin of claim 1, wherein each R is independently a C₄-C₁₂ alkyl.

6. The resin of claim 5, wherein each R is independently a tert-butyl moiety or tert-octyl moiety.

7. The resin of claim 1, wherein Z is

[chemical structure]

8. A process for preparing a resin composition with a high methylol content, comprising the steps of:
a) reacting an alkylphenol with aldehyde in an aprotic solvent in the presence of a base catalyst at a temperature ranging from about 80 to about 160° C. to form a first resin, wherein the aldehyde:phenol molar ratio is from about 0.3:1 to about 0.9:1;
b) reacting the first resin with additional aldehyde at a temperature ranging from about 40 to about 75° C., wherein the aldehyde:phenol molar ratio is from about 0.4:1 to about 2.0:1;
c) neutralizing the resin with an acid to a pH of less than 7 to form a modified resin with methylols; and
d) subjecting the modified resin to a rapid devolatilization technique to remove the solvent while preserving the methylol groups on the modified resin.

9. The process of claim 8, wherein the high methylol content is achieved by having a ratio of methylol groups to ether groups in the resin composition of from 0.5:1 to about 2:1.

10. The process of claim 8, wherein the high methylol content is achieved by having no ethers present in the resin composition.

11. The process of claim 8, wherein the aldehyde is formaldehyde.

12. The process of claim 8, wherein the rapid devolatilization technique removes greater than 99% of the solvent at temperatures ranging from about 145 to about 175° C.

13. The process of claim 8, wherein the rapid devolatilization technique is performed using a thin film evaporator.

14. The process of claim 13, wherein the thin film evaporation is performed under vacuum.

15. The process of claim 13, wherein the thin film evaporation is performed in a semi-continuous or continuous manner.

16. The process of claim 8, wherein the process does not include a final batch distillation step.

17. The process of claim 8, wherein the process does not include a final vacuum-mediated batch distillation step.

18. The process of claim 8, wherein the alkylphenol contains C₄-C₁₂ alkyl groups.

19. The process of claim 18, wherein the alkylphenol is para-tert-butylphenol or para-tert-octylphenol or a combination thereof.

20. The process of claim 18, wherein the alkylphenol is a mixture comprising more than one alkylphenols containing C₄-C₁₂ alkyl groups.

21. The process of claim 8, wherein the alkylphenol is an unpurified alkylphenol prepared in-situ.

22. The process of claim 8, wherein the alkylphenol is an ortho-alkylphenol.

23. The process of claim 8, wherein the base catalyst is selected from the group consisting of ammonium hydroxide, triethylamine, triethanolamine, diethyl cyclohexyl amine, triisobutyl amine, potassium hydroxide and combinations thereof.

24. The process of claim 8, wherein reaction step (a) and/or reaction step (c) is further subjected to vacuum-mediated azeotropic distillation to remove water.

25. The process of claim 8, wherein the aldehyde:phenol molar ratio of reaction step (a) is from about 0.5:1.0 to about 0.6:1.0.

26. The process of claim 8, wherein the aldehyde:phenol molar ratio of reaction step (b) is from about 1.2 to 1.0 to about 1.8 to 1.0.

27. The process of claim 8, wherein the aprotic solvent is xylene or toluene.

28. A process for preparing a resin composition with a high methylol content, comprising the steps of:
a) reacting an alkylphenol with aldehyde in an aprotic solvent in the presence of an acid catalyst at a temperature ranging from about 80 to about 160° C. to form a first resin, wherein the aldehyde:phenol molar ratio is from about 0.3:1 to about 0.9:1;
b) adding excess base catalyst to raise the pH above 7;
c) reacting the first resin with additional aldehyde at a temperature ranging from about 40 to about 75° C., wherein the aldehyde:phenol molar ratio is from about 0.4:1 to about 2.0:1;
d) neutralizing the resin with an acid to a pH of less than 7 to form a modified resin with methylols; and
e) subjecting the modified resin to a rapid devolatilization technique to remove the solvent while preserving methylol groups on the modified resin.

29. The process of claim 28, wherein the high methylol content is achieved by having a ratio of methylol groups to ether groups in the resin composition of from 0.5:1 to about 2:1.

30. The process of claim 28, wherein the high methylol content is achieved by having no ethers present in the resin composition.

31. The process of claim 28, wherein the aldehyde is formaldehyde.

32. The process of claim 28, wherein the rapid devolatilization technique removes greater than 99% of the solvent at temperatures ranging from about 145 to about 175° C.

33. The process of claim 28, wherein the rapid devolatilization technique is performed using a thin film evaporator.

34. The process of claim 33, wherein the thin film evaporation is performed under vacuum.

35. The process of claim 33, wherein the thin film evaporation is performed in a semi-continuous or continuous manner.

36. The process of claim 28, wherein the process does not include a final batch distillation step.

37. The process of claim 28, wherein the process does not include a final vacuum-mediated batch distillation step.

38. The process of claim 28, wherein the alkylphenol contains C₄-C₁₂ alkyl groups.

39. The process of claim 38, wherein the alkylphenol is para-tert-butylphenol or para-tert-octylphenol or a combination thereof.

40. The process of claim 38, wherein the alkylphenol is a mixture comprising more than one alkylphenols containing C₄-C₁₂ alkyl groups.

41. The process of claim 28, wherein the alkylphenol is an unpurified alkylphenol prepared in-situ.

42. The process of claim 28, wherein the alkylphenol is an ortho-alkylphenol.

43. The process of claim 28, wherein the acid catalyst is selected from the group consisting of p-toluene sulfonic acid, dodecylbenzene sulfonic acid, xylene sulfonic acid, and combinations thereof.

44. The process of claim 27, wherein reaction step (a) and/or reaction step (d) is further subjected to vacuum-mediated azeotropic distillation to remove water.

45. The process of claim 28, wherein the aldehyde:phenol molar ratio of reaction step (a) is from about 0.5:1.0 to about 0.6:1.0.

46. The process of claim 28, wherein the aldehyde:phenol molar ratio of reaction step (b) is from about 1.2 to 1.0 to about 1.8 to 1.0.

47. The process of claim 28, wherein the aprotic solvent is xylene or toluene.

48. A bladder formulation comprising an uncured elastomer, a halogen-containing compound, and the resin of claim 1.

49. The bladder formulation of claim 48, further comprising an activator, process oil, stearic acid, filler, lubricant, plasticizer, dispersant and/or extender.

50. The bladder formulation of claim 49, wherein the activator is zinc oxide.

51. The bladder formulation of claim 48, wherein the halogen-containing compound is neoprene W.

52. The bladder formulation of claim 48, wherein the uncured elastomer is butyl rubber or halogenated butyl rubber.

53. A vulcanized elastomer composition prepared by vulcanizing the bladder formulation of claim 48.

54. A resin composition prepared by the process of claim 8.

55. The resin composition of claim 54, wherein the unreacted monomer is less than 1%.

56. The resin composition of claim 54, wherein the unreacted monomer is less than 0.5%.

57. The resin composition of claim 54, wherein the unreacted monomer is less than 0.2%.

58. A method of increasing thermal stability in a rubber composition by curing said rubber composition with a resin of claim 1, wherein the cured rubber composition, when subjected to a heat treatment carried out at a temperature of 160° C. for at least 72 hours, undergoes a change in modulus at 100% elongation, between 24 hours and 72 hours of the heat treatment, of less than 25%.

59. The method of claim 58, wherein the change in modulus at 100% elongation, between 24 hours and 72 hours of the heat treatment, is less than 15%.

60. The method of claim 58, wherein the change in modulus at 100% elongation, between 24 hours and 72 hours of the heat treatment, is less than 10%.
